(19) United States
(12) Patent Application Publication
(10) Pub. No.: US 2014/0278850 A1
(43) Pub. Date: Sep. 18, 2014

(54) CROWD SOURCING BUSINESS SERVICES

(71) Applicant: VAULT VENTURES LLC, New York, NY (US)

(72) Inventors: John Boccuzzi, JR., Newtown, CT (US); Peter Anthony Komassa, New York, NY (US); Joseph Anthony Sofio, New York, NY (US)

(21) Appl. No.: 13/838,645

(22) Filed: Mar. 15, 2013

(51) Int. Cl. G06Q 30/02

(52) U.S. Cl. CPC G06Q 30/0208
USPC 705/14.11

(57) ABSTRACT

Business services are crowd sourced via a system including a database of customer data and participant data, a web server, an app server, and an analytics engine. The system is configured to distribute tasks to suitable participants, to assess task data generated by participants, and to award incentives to participants based on the task data.

### BACKGROUND

1. Technical Field

The present invention relates to methods and devices for providing business services and, more particularly, to a computerized system for efficiently connecting retail businesses with crowd sourced business services.

2. Discussion of Art

“Retailers,” in context of this disclosure, include groceries, clothing stores, convenience stores, and other businesses that sell tangible products from physical locations. As such, retailers are in need of location-specific business services. Such location-specific services include, for example, retail audits or mystery shopping.

Retail audits and mystery shopping are methods for sampling the customer experience delivered at a particular retail location or across a set of retail locations. High-quality storefront and in-store customer experiences are key to obtaining spend that otherwise would go to competing retailers or to online sellers. Traditionally, retailers have relied principally upon store managers to assess customer experience (including customer complaints) and to confirm whether retail employees and product displays appropriately implement corporate standards for customer experience (“retail audits”). However, retail audits may fail in accuracy, objectivity, or thoroughness for a variety of reasons. Due to perceived deficiencies in the objectivity, thoroughness, or accuracy of retail audits, retailers have sometimes turned to outside auditors (“mystery shoppers”), who are contracted to provide detailed reports on customer experience from various perspectives (e.g. different ethnicities, ages, shopping habits, or customer service requirements). Mystery shoppers often are trained to note and report details that are subliminal to other customers (e.g., a degree of uniformity of product label facing on an “endcap” aisle display).

“Crowd sourcing” refers to a practice of obtaining needed services, ideas, or content by soliciting contributions from a large group of people and especially from an online community rather than from traditional employees or suppliers. Conventionally, crowd sourcing has been used for discrete tasks that do not involve tangible products or physical presence; e.g., data processing, collaborative writing, web content development, etc. Crowd sourcing requestors have conventionally presumed that each responding participant possesses a threshold level of skill required for performing the particular task, and have implemented quality controls solely on a post facto basis (i.e., by screening completed submissions for quality against objective criteria such as clarity or correct spelling). Crowd sourcing also presumes ad hoc interactions, without repeat performance of similar tasks. Wikipedia™ and Kickstarter™ are two quintessential examples of respectively crowd sourcing encyclopedic information and funding.

Many aspects of retail audits and mystery shopping are understood to require a level of skill that is difficult to attain and also is difficult to assess post facto (i.e., it is difficult to set objective criteria for determining whether a retail audit was properly accomplished, without actually repeating the audit). Additionally, mystery shopping and retail auditing are fundamentally location-based services that relate to a performer's presence in a given retail location. These characteristics have so far precluded crowd sourcing of mystery shoppers or retail auditors.

Other location-specific services also are required by retailers, and similarly to retail audits or mystery shopping, have not so far been crowd sourced.

### BRIEF DESCRIPTION

According to the present invention, a mobile device is configured to alert a user of the mobile device (a potential participant in the invention) of proximity and availability of a location-based task. Thus, embodiments of the invention provide a web and mobile platform that connects businesses (“customers”) with consumers (“participants”) who are willing to collect and supply market data, or perform other tasks, in exchange for rewards. The invention facilitates exchange of data and rewards through a database and analytics engine that support the website and the mobile app. The task data is compiled, sorted and analyzed using the analytics engine, which may be cloud-based. The results are presented to the customers via the website, using charts, graphics and other objects within a reporting tool. The invention thereby enables businesses (the customers) to obtain, measure, and optimize in-store information in real-time from the crowd sourced participants. Overall, the invention provides a consumer-driven audit solution that boosts sales volume and engagement through unique rewards.

Embodiments of the invention include a participant-facing mobile app that connects through a cloud or proprietary server analytics engine to a customer-facing web interface. The mobile-server-web platform connects business customers seeking in-store audits with an on-demand workforce of consumer participants seeking discounts, reputation, or simple cash rewards. Because repeat participants can gain enhanced rewards through consistent quality of production, customers can receive audits of higher quality and lower cost than available via other avenues. Moreover, retail business customers can leverage the task referral system to obtain valuable crowd sourced services while also driving foot traffic, building brand loyalty, and enhancing sales through the distribution of rewards to consumers who are in-store and engaged with specific product categories.

These and other objects, features and advantages of the present invention will become apparent in light of the detailed description thereof, as illustrated in the accompanying drawings.

### DRAWINGS

FIG. 1 shows in schematic view a system and process for crowd sourcing business services according to embodiments of the present invention.

FIG. 2 shows in schematic view particular components and data flows of the system shown in FIG. 1.

FIG. 3 shows in schematic view an interface for requesting crowd sourced tasks.

FIG. 4 shows in schematic view a conditional logic interface for developing crowd sourced task step dependencies.

FIG. 5 shows in schematic view an interface for reporting results of crowd sourced tasks.

FIG. 6 shows in schematic view steps of a process for analyzing crowd sourced task data and generating results of crowd sourced tasks.

FIG. 7 shows guidelines for a status point system.

FIGS. 8 and 9 show in schematic view a task selection interface of a mobile app according to embodiments of the present invention.

FIG. 10 shows in schematic view a task detail screen of the mobile app.

FIG. 11 shows in schematic view a task queue of the mobile app.

FIG. 12 shows in schematic view a task performance interface of the mobile app.

FIG. 13 shows in schematic view advanced applications of the mobile app.

### DETAILED DESCRIPTION OF THE DRAWINGS

Referring to FIG. 1, a database 10 is connected in communication with businesses (“customers”) 12 via a website 14 and in communication with consumers (“participants”) 16 via a mobile app 18. The database 10 stores customer data 20 and participant data 22. Using the website 14, the customers 12 can submit requests 24 for entry into the database 10. Each request describes a task 26, with an associated reward 28.

The various tasks 26 that may be requested may include, for example, mystery shopping of a particular department within a retail location; photography or videography of a seasonal product display; verification of a private label product display; store cleanliness inspections; signage checks; stock checking; price label verifications; identification of new item marketing; validation of a promotional display. Rewards 28 may include cash, store credits, gift cards, coupons, or other incentives such as event tickets, a VIP invitation, access to a special checkout lane or process, factory tours, gift items, a party, concierge service, sharable coupons, in-store recognition (named offerings or discounts), or special access to customer service.

The database 10 is structured to make the tasks 26 available to the participants 16, generally, for completion according to particular requirements 30 associated with each task. The task requirements 30 may include, for example, a location 30a for performing the task, a sequence of steps 30b for accomplishing the task, and/or one or more deliverables 30c. Through performance of the task(s) 24 by one or more participants 16, the database 10 receives task data 32, which fulfills the deliverables 30c. Exemplary deliverables may include a photograph, a video, a set of multiple-choice and/or freeform responses to a survey, or merely a confirmation that a particular location was visited (i.e. a “check in” using geo-location of the performing participant 16). For example, the task data 32 may include a geo-tag 32a, a time stamp 32b, survey responses 32c, quality points 32d, and a photograph 32e.

In association with the database 10, an analytics engine 34 compiles and analyzes the task data 32, and provides to one or more of the customers 12 one or more results 36 derived from the task data. The analytics engine 34 also credits the appropriate reward(s) 28 to the participant(s) 16 who complete the task(s) 26.

In certain embodiments, such as the exemplary embodiment shown in FIG. 2, the customer data 20 includes for each business (customer) at least an identity 20a, a listing 20b of locations, a listing 20c of requests 24, and a listing 20d of results 36. The identity 20a includes, for example, a billing address, an address for legal service, and a corporate name. The listing 20c of requests 24 may include data indicating that certain requests are related as a “campaign.” The listing 20d of results includes for each result 36 one or more references, links, or other associations with the underlying task data 32. As further discussed below, each result 36 may be a compilation or derivation from multiple sets of task data 32. Other data items may be included in the customer data 20. For example, as further discussed below, the customer data 20 may include a history of rewards 28 that have been authorized to participants 16.

As shown in FIG. 2, the participant data 22 may include an identity 22a, a location history 22b, a list 22c of available tasks, a queue 22d of accepted tasks, and a record 22e of completed tasks. The identity 22a includes, for example, a payment method, a name, and a status indicator as further discussed below. The record 22e of completed tasks includes, for each task 26, the associated task data 32.

The database 10 is connected in communication with the analytics engine 34, a web server 38 (which serves instances of the web interface 14), and an app server 40 (which serves instances of the mobile app 18). Although the analytics engine, web server, and app server are conceptually distinct, some or all may be embodied in a same computing device (processor and associated data storage) or may be distributed across several or many computing devices, e.g., in a cloud or virtual machine configuration. For convenience only, the different functions are described herein as being accomplished by different devices or system components. Operation of these system components is further discussed below.

Still referring to FIG. 2, the analytics engine 34, the web server 38, and the app server 40 are configured to cooperate according to an algorithm 42. Starting from the aspects of the invention that face the customers 12, the web server 38 is configured to serve instances of the website 14. In response to a first customer input 44 (e.g., an HTTP request for the website 14), the web server 38 is configured to present 46 via the website 14 a task request form 48 (of which an example is shown in FIG. 3, below), by which a customer 12 can submit 50 a request 24 that specifies a task and associated reward(s). The task request form 48 can be customized to offer a variety of rewards, as discussed above. Moreover, the task request form 48 can be customized to specify any of a variety of tasks as discussed above, such as information gathering (e.g., consumer preference information, shelf stocking data, product location within a store) but may also include brand awareness or product promotion (e.g., obtain a picture of a person consuming or using a product; obtain one or more reviews of a brand or product). The web server 38 is further configured to enter 52 the received request 24 into an appropriate listing 20c within the requesting customer's data 20. The web server 38 also is configured to, in response to a second customer input 54, retrieve 56 results 36 from the customer data 20, and is further configured to display 58 the results via the web interface 14, for example in the form of a report 60 (of which an example is shown in FIG. 5, below).

The analytics engine 34 is configured by the algorithm 42 to monitor 62 the customer data 20 for new requests. On detecting 64 a new request, the analytics engine 34 is further configured to poll 66 the participant data 22, thereby identifying 68 participants 16 whose data 22 matches the corresponding task requirements 30. For example, the analytics engine 34 polls 66 the participant data 22 for identifying 68 participants 16 whose location histories 22b include one or more locations proximate the task location requirement 30a. In this context, “proximate” could be defined by a participant-selected time or distance “out of the way” from the nearest point of the participant's location history 22b; alternatively, “proximate” could be defined by a customer-selected time or distance from a closest or most recent point of the participant's location history. Other variations of “proximate” will be apparent in light of these examples. For example, a task location requirement 30a that is “proximate” to a point of a participant's location history 22b could be defined as no further distant than a dimension of a shape (e.g., a radius of a best-fit circle) as formed by the locations of the participant's submitted task record 22e.

Other requirements may include participant data relevant to obtaining consumer preference survey information; for example, the participant's shopping history 22f, occupation, location history, etc. For example the analytics engine 34 may identify 68 a first group of participants 16, each of whom generally travels within a one mile radius from a central location, and who purchase infant diapers and formula on a weekly basis; or a second group of participants 16, each of whom routinely travels in excess of 100 miles, and who sporadically purchase business periodicals at airports.

Other requirements may include participant identity data 22a such as participant status. For example, a customer 12 may only want its tasks performed by participants who have established a longstanding reputation for quality work.

On identifying 68 one or more participants 16 who suit the requirements 30 of a new request 24, the analytics engine 34 updates 70 the participant data 22 to incorporate the new task 26 into the participant list(s) 22c of available tasks. Thus, the analytics engine 34 is configured to flow task requests 24 from the customer data 20 into the participant lists(s) 22c of available tasks 26.

The analytics engine 34 also is configured by the algorithm 42 to monitor 72 the participants' records 22e of completed tasks for updated task data 32. On detecting 74 updated task data 32, the analytics engine 34 analyzes 76 the updated task data and generates 78 results 36 within the appropriate customer's listing 32d of results. Steps of analyzing 76 and generating 78 are further discussed below with reference to FIG. 6. Thus, the analytics engine 34 is configured to flow actionable task data 32 from the participant records 22e into the customer data 20.

Meanwhile, referring back to FIG. 2, the app server 40 is configured by the algorithm 42 to serve 80 each instance of the mobile app 18. For clarity, only a single instance of the mobile app 18 is shown, however, it is contemplated that many instances are simultaneously served by the app server 40.

In response to a first participant input 82 (e.g., activation of an instance of the mobile app 18 at a mobile device, as further discussed below with reference to FIG. 8), the app server 40 retrieves 84 from the database 10 that particular participant's data 22, then pushes 86 the data 22 to the participant's instance of the mobile app 18, including the list 22c of tasks 26 for which the particular participant 16 has been identified. The list 22c of tasks may be correlated to tasks previously accepted or completed by the participant—e.g., if the participant has previously completed retail audits in grocery stores, the list of tasks may include retail audit tasks as well as grocery store tasks. As further discussed below, the list 22c can be sorted by proximity to the mobile device. In certain embodiments, when the mobile device is very close to a task location—e.g. entering a store—then the mobile app 18 may alert the participant to immediate availability of a task for completion.

The app server 40 monitors each active instance of the mobile app 18 for data pushed from the mobile app to the app server in response to participant inputs. For example, in response to a second participant input 88 (e.g., operation of the mobile app 18 to “add to queue” a task 26 from the displayed list 22c, as further discussed below with reference to FIG. 8), the mobile app may push 90 to the app server 40 an updated queue 22d.

As another example, in response to a third participant input 92 (e.g., operation of the mobile app 18 to “claim now” a task 26 from the displayed list 22c, as further discussed below with reference to FIG. 9), the mobile app may signal 94 to the app server 40 that the claimed task 26 should be de-listed or marked as claimed in other participants' task lists 22c. Additionally, the mobile app 18 may record in the participant data 22, and in the customer data 20, a time and location of task acceptance. This information, in aggregate, can provide a better understanding as to when and where consumers engage their mobile devices and as to how tasks or offers can be better presented.

As another example, in response to a fourth participant input 96 (e.g., selecting a button in the mobile app 18 to “submit” a particular task 26, as further discussed below with reference to FIG. 9), the mobile app may push 98 new task data 32 to the app server 40. Responsive to data or signals received from instances of the mobile app 18, the app server 40 periodically updates 100 the participant data 22.

FIG. 3 shows in schematic view an interface, e.g., the task request form 48, by which a customer 12 can request a crowd sourced task. Adjacent an upper edge of the form 48 can be seen tabs of other forms, including the report 60, a map and listing 20b of customer locations, a history 102 of rewards and payments authorized to participants 16, and a listing 20c of requests outstanding within the inventive system 10. The listing 20c is labeled as “My Campaigns” because the outstanding requests can be displayed in groups (“campaigns”) corresponding to categories such as store location or product code.

The exemplary task request form 48 is a simple, flexible, and intuitive tool for building a custom interface that will present a multi-step task to a participant. The form 48 includes at its left side a brand logo 104, a product selection pulldown 106, and a product illustration 108. To the right of the brand logo 104, the form 48 includes a location select box 110. One or more task locations 26a can be selected from a pulldown list, or a pop-out map of potential task locations can be accessed via a map display button 112. Below the location select box 110 is a task submittal box 114, which tracks the total number of steps 26b within the new task request, and which includes a submittal button 116 for either closing the task request form 48 and adding the new task to the customer's request listing 20c (“Add Task”) or simply closing the task request form and returning to the request listing 20c (“Cancel”).

Below the task submittal box 114 is a new step box 118. Within the new step box 118, the customer 12 can select a step/response type 120 and step parameters 122. Next to each step/response type, the new step box 118 includes a mockup of what will be displayed to a participant 16 performing the current step; e.g., for a price check, the participant will see question text, a left-right slider, a numeric dial, and a currency selection; for a yes/no question, the participant will see question text and a YES/NO switch. For a photo or video type step, selecting a “model photo” button 124 will cause display of a pop-out window for the customer to upload a model photo that will be displayed to a participant performing the step. Selecting a preference matrix type step will cause display of a pop-out window, by which the customer 12 can specify rows and columns of the preference matrix. For example the customer 12 may specify as rows a set of products (e.g., “[BRAND 1] instant oatmeal; [private label] instant oatmeal; [private label] slow cook oatmeal; [BRAND 2] hot wheat cereal”) and as columns a spectrum of purchasing attitudes (e.g., “would never consume; would never purchase; significantly less likely to purchase; less likely to purchase; might purchase; more likely to purchase; significantly more likely to purchase; sometimes purchase; regularly purchase”).

The customer 12 also can select 130 whether conditional logic will affect display of the particular task step, e.g., whether the task step will be displayed or not displayed based on completion or non-completion of a previous step. Selecting conditional logic 130 will cause display of a pop-out logic window 132, as shown in FIG. 4.

The new step box 118 further includes an “Add Step” button 134, whose function and purpose are evident; and a reward/payment box 136, which the customer 12 can use to set 136 one or more rewards 28 to be authorized for a participant 16 who completes the requested task 26.

Referring to FIG. 4, the pop-out logic window 132 provides controls for establishing a conditional task flow 138, which includes representations of the steps 26b that will be performed according to outcomes of previous steps. The controls include links 138a, branches 138b, gates 138c, and sequence labels 138d. FIG. 4 presumes that most of the steps require yes/no type responses, however, the branches 138b are equally adaptable to ranges of numerical responses or to lengths of free text field responses. The sequence labels 138d permit re-ordering steps within the conditional task flow 138 so that, for example, step “F” (a free response question, asked dependent on the result of step “C”) is presented with a group of other free response questions, rather than immediately after step “C.” In certain embodiments, as further discussed below with reference to the mobile app, the sequence labels also can toggle whether a step will be displayed, not displayed, or displayed greyed-out in case the step is not enabled by the conditional logic.

Exemplary tasks for consumer packaged goods (CPGs) customers (e.g., Campbells, Kraft, Budweiser) can include general retail audits; audits of end caps in stores; audits of signage in stores; verification of in-store promotions; stock checks; verifying display of new items or product launches; checking in-store positioning of products and promotions; comparing product prices to competitors; polling consumers on product preferences; mystery shopping a product (e.g., the “where is xxx product?” question); obtaining participant feedback on products or promotions; sharing products and deals via social media (SMS, Twitter, FB, etc.); and promoting consumer brand photo contests.

For retailers (e.g., Supervalu, Best Buy), exemplary tasks may include auditing compliance of product packaging, displays, shelf ads, in-aisle coupon dispensers, cart talkers, shelf banners, and shelf talkers with promotional planning; checking departments for adherence to corporate performance standards; auditing seasonal displays; stock checking private label merchandise; verifying shelf and product compliance to planograms; checking store cleanliness; timing checkout or department (e.g. deli) lines; store preference polling; feedback on customer service; feedback on store environment; sharing products and deals via social media (SMS, Twitter, FB, etc.); contests; and general mystery shopping.

Restaurants (e.g., Dennys, Arbys) can use the invention to obtain mystery dining services, which can provide real-time feedback on food, customer service, and restaurant appearance; photos of actual plates to verify the food presentation complies with corporate guidance; real-time data on service times; social media sharing of deals and food reviews; as well as correlation data relating weather or recent participant purchases to restaurant ordering.

Other customers may also use the invention for local information such as verification of business locations; in-store ‘channel checks’ of products for investment firms; real estate checks of property conditions or sale signage; neighborhood exploration; political campaign signage checks; or general widespread polling or consumer preference feedback including custom surveys on any topic.

FIG. 5 shows in schematic view the report 60, by which a customer 12 can review results 36 of a crowd sourced task 26. The report 60 includes various display controls for adjusting how the results 36 are presented.

Referring to FIG. 6, the results 36 as shown in the report 60 are developed by the analytics engine 34 from the task data 32 via processes of analyzing 76 the task data and thereby generating 78 the results. The process of analyzing 76 begins with detecting 74 the new task data 32 among the participant data 22. Then the analytics engine 34 disaggregates 140 the new task data 32 into discrete responses 142, each of the responses having a particular type 120 (e.g., chronologic, locational, UPC, photographic, video, numeric, text, multiple choice) and topic 144 (e.g., task acceptance, target store 146, target product 148, product display, product quantity, product price, participant target price for product, participant evaluation of display context, participant buy preference, participant attitude toward brand, task submittal). The analytics engine 34 then assesses 150 each discrete response 142 according to one or more heuristics 152 corresponding to the response type 120. Each heuristic 152 includes a quality point aspect which contributes input to a participant status point system 156 as further discussed below with reference to FIG. 7.

For example, the heuristics 152 include a photo/video image recognition module 154, which assesses parameters such as pixel quantity, pixel quality, and picture orientation by comparison to a model photo. Photograph- or video-type responses below threshold levels of pixel quantity or quality (‘blurry photos’) will not provide a quality bonus. Images that were supposed to be landscape and are portrait style will not receive a quality bonus. Further, for responses that meet the thresholds for pixel quantity and quality, the image recognition module 154 counts the number of facings a product has, if a product is out-of-stock, and the shelf positioning of a product relative to competitor products.

For free-text responses, the heuristics 152 include a textual analysis module 158, which may assess such parameters as spelling, grammar, and relevance to user-selected key words, as well as response length. The textual analysis module 158, like the image recognition module 154, connects with the point system 156. Thus, participants 16 can gain status by providing quality photography and by providing text responses that are of adequate length and are in tune with the concerns of the customers 12.

For non-text, non-image responses (e.g., preference matrix, multiple choice, yes/no, numerics), the heuristics 152 include a simple check whether all responses were completed. Additionally, for the entire task, the heuristics 152 include a timeliness standard that can be set by the customer 12. Meeting or exceeding these standards contributes quality points 160 toward the status point system 156.

As another option for the heuristics 152, the analytics engine may assess the participant's compliance history or status points (stored as part of the identity data 22a or as part of the task record 22e) in order to determine whether the task data 32 should be flagged for manual review.

Continuing to the process of generating 78 results 36, the analytics engine 34 pulls 162, from the customer data 20, previous results 36 that match the topic 144 and the target store 146 and/or target product 148 of each disaggregated response 142. The analytics engine 34 aggregates 166 the disaggregated responses 142 into the results 36, and writes 168 the updated results 36 back to the customer data 20. Optionally, the analytics engine 34 aggregates the disaggregated responses using a confidence weighting function based on participant identity 22a, and in particular based on the participant's status. In other embodiments, the analytics engine 34 may adjust a confidence indicator of the updated results 36, based on the participant's status.

Referring to FIG. 7, the status point system 156 is a tiered point system to reward participants 16 for frequency and quantity of engagement, accuracy of responses, timeliness of task completion, social promotion of task products, and community involvement, while discouraging fraud and other negative behavior. In an exemplary embodiment, the tiered system includes five primary rankings (e.g., “chipmunk, ground squirrel, tree squirrel, flying squirrel, marmot”) each including five minor tiers (e.g., “California chipmunk, Eastern Chipmunk, Alpine chipmunk, Durango chipmunk, Siberian chipmunk”). Points are awarded each time a participant submits a chosen task results (positive), or each time a chosen task “times out” (negative).

Each participant 16 begins with a pool of points, which is augmented by positive behavior and diminished by negative behavior. In case a participant's points go negative, the participant is banned for a period of time, which can be related to the negative point amount. In some cases, participants may earn “longevity” points simply for being signed up. In some cases, these longevity points may be earned even while banned, in order to reduce a negative point total.

Users with higher rankings will in some instances get to see tasks first or have access to tasks that others do not. In addition, higher ranking users may get paid more for some tasks. E.g., a task to photograph a product display may pay $1 to all users with a $0.25 bonus for ground squirrels, $0.50 bonus for tree squirrels, $0.75 bonus for flying squirrels and a $1 bonus for marmots. As such, beyond the bragging status of achieving a high ranking, users will want to strive to earn points so that they can earn more money on tasks.

In addition, and further fostering a sense of community, certain tasks will give out a monetary or quality point bonus if a predetermined threshold of tasks are completed by a defined date. For example, if 80% of the available tasks for a given campaign are completed within the first 5 days, everyone who has completed a task within the campaign may receive a $1 bonus and 200 extra quality points.

In certain embodiments, the status point system 156 may be a social system, such that the participant data includes data on referral links 157 between referring participants. In other words, positive or negative points awarded to a first participant 16a may result in a lesser number of positive or negative points being awarded to or shared with other participants 16b who are in a referral relationship with the first participant (either having invited the first participant to the mobile app 18, or having been invited by the first participant). For example, a referrer or referee may share 10% of the points (plus or minus) that are awarded to their referees or referrer. In other embodiments, participants may establish non-referral links or team relationships for the purpose of point-sharing. It is expected that such embodiments will encourage mutual quality control among linked participants.

Turning to FIGS. 8-12, the participants 16 experience the invention via the mobile app 18. When first activated on a given participant's mobile device, the mobile app 18 displays the participant's list 22c of available tasks. The list is displayed either in a scrolling format 170 (FIG. 8)—which can be sorted by distance, time, customer, or reward among other criteria—or in a map format 172 (FIG. 9). Referring to the sort functionality of the scrolling format 170, this will allow users to display unclaimed, claimed, and completed tasks, ordered by proximity, reward amount in dollars or points, or time to end of campaign, and grouped by grocery store, product type, or brand. By default, tasks are displayed in order by proximity; for approximately the same proximity, tasks are grouped by claimed vs. unclaimed; and within groups, tasks are ranked by reward amount. Tasks also can be searched by store or brand.

Within the scrolling list form 170, each task is displayed as a task button 173, which for example displays store location on left, product brand in the middle, and reward on the right. The task buttons may be differentiated as unclaimed by anyone, or claimed but not completed. Typically, completed tasks will not be displayed.

By selecting a task button 173, the participant can access a task detail screen 174 (FIG. 10), which displays the task location, a map to the location, a synopsis or brief description 175 of the task (including model photo and time constraints as well as the potential task rewards), buttons to “add to queue” 176 or “claim now” 178 as discussed above with reference to FIG. 2, a brand logo, and a button 186 for sharing the task via a social network. Once a task has been claimed by a number of participants set by the requesting customer (by default, 25 participants), the task will no longer be displayed to new users.

Like the task list 22c, the task queue 22d can be displayed in scrolling format 170 (FIG. 11) or in map format 172, using task buttons 173 similar in appearance to those presented on the list screen. As discussed above, the task queue is populated by selecting “add to queue” on each task. Within the task queue screen, tasks are as ‘Open’, ‘Pending Review’, ‘Accepted’, ‘Denied’, or ‘Expired.’ ‘Open’ tasks are auto-sorted by proximity. By selecting a task button 173 in the queue 22d, or by “claiming now” from the list 22c of available tasks, the participant can access a task performance screen 180 (FIG. 12), which remains active in the mobile app 18 until the participant “submits” 182 the selected task. The task performance screen 180 displays the task steps according to the conditional task flow 138. For example, in certain embodiments, each step is displayed only if it is enabled based on results of previous steps. In other embodiments, non-enabled steps are displayed but grayed-out. In other embodiments, the customer 12 can select whether particular steps will be grayed-out or entirely hidden if they are not displayed. (A particular example is that the customer may not want to display “Will you buy this product at a lower price?” when the participant has expressed willingness to buy the product at the current price; but may want to display other steps, such as obtaining a product sample coupon, which will be enabled only after appropriate completion of prior steps.)

Once a task is “submitted” 182, then if the task meets the heuristics 150, and the participant was first to submit the task, the task is ‘Accepted’ and the participant's data is updated to indicate the dollar amount, points, and any other rewards (such as a special coupon) that are earned for task completion. Later participants who submit the same task will just get special prizes. On the other hand, if the task does not meet the heuristics 150, then it is ‘Denied’ and can be linked to an automated explanation of the denial. Tasks not completed within the allotted time from selection, are ‘Expired’ with corresponding negative points awarded to the participant.

Also on task completion, the mobile app 18 displays a reward screen 188 as further discussed below with reference to FIG. 13.

From any screen of the mobile app 18, the participant can access the queue 22d, account options (“My Account”) 184, or social networks 186. The queue 22d has been described with reference to FIG. 11. The account options 184 include a record of rewards (money, points, badges, or special coupons/prizes) earned as well as an option to share info on dollars, points, badges, coupons, or tasks on social networks. Special status can be tracked including the number or percentage of claims on which the participant was first to complete; numbers or percentages of claims accepted, denied, or expired; customer, brand, or product category for whom participant has completed most tasks; favorite recipe; and other participant identity info. Also under the “My Account” tab, the participant can link up ‘Paypal’ to receive instant payment or to sign-up for a prepaid debit card which money is loaded to; however, by default, the participant can elect to receive gift cards in increments of $5. As another feature, the “My Account” tab enables the participant to link the mobile app 18 to one or more store loyalty accounts, which are incorporated into the participant data 22 as purchase histories 22f.

When a store loyalty account is linked, the app server 40 detects a corresponding purchase history 22f and therefore activates a “store check-in” feature 190 to serve the reward screen 188 (FIG. 13). Under the store check-in feature 190, when the mobile app 18 notifies 96 the app server 40 that a participant has completed a task, the app server 40 pulls 192 location-relevant data from the participant's purchase history 22f, develops 193 a targeted list 194 of items that the participant may be willing to purchase at the task location, and pushes 196 the list to the mobile app; the mobile app 18 then displays 198 the targeted list 194 at the reward screen 188. For example, if the participant 16 has purchased oat cereal every 14-16 days on average and it has been 12 days since their last purchase, the mobile app 18 will display an in-store reminder about oat cereal The targeted shopping list 194 also may include targeted incentives 199 offered by customers 12. For example, along with the in-store reminder about oat cereal, the reward screen 188 may display two manufacturers' coupons for such cereal along with an alert regarding a competitive private label version of the product. Preferably, the targeted incentive(s) 199 are displayed immediately after task completion, i.e., while the participant remains in the task location. However, in other embodiments, follow-on targeted incentives may be pushed to the mobile app 18 on one or more subsequent visits to the same task location or to a related task location (e.g., related by same customer 12 or by same product 148).

The targeted incentives 199 may be selected based purely on the product category of the completed task. However, according to the illustrated embodiment, the targeted incentives 199 are chosen by the analytics engine 34 based on correlation data 202 as further discussed below.

In particular, while monitoring 72 the participant data 22, the analytics engine 34 can develop 200 correlation data 202 based on the participants' completed task records 22e and their shopping histories 22f, and can generate 78 results 36 that incorporate this correlation data. For example, if a participant completes a task that requires photographing a customer's private label potato chip display, the correlation data 202 can indicate whether or which brand of chips the participant purchased, and whether it was the first time the participant tried that brand of chips. Moreover, the correlation data 202 can include cross-brand retail data developed from a larger population of participants. For example, for a population of participants who have completed tasks that require photographing fishing lure displays in sporting goods stores, the correlation data 202 may indicate that many of those participants then purchased beer and gasoline at convenience stores near the fishing lures. Thus, based on the correlation data 202, the analytics engine 34 may choose 204 appropriate incentives 199, which the analytics engine then may push directly to the app server 40, for presentation via the mobile app 18 to other participants who complete a fishing lure related task.

Another example of correlation data 202 would be use of image recognition technology module 154 in combination with themed photo contests. For example, a set of tasks may require participants to obtain photos of themselves posing in-store with their favorite beverage while wearing their favorite sports team apparel. Using image recognition processing (module 154) to identify beverage packages and team logos within these photos, combined with use of geo-location to identify customers 12, the analytics engine 34 could derive correlation data 202 including participants' preference relationships between sports teams, customers 12, and beverage brands.

Under the social option 186, and via the social networks to which they belong, participants are enabled to share photos, videos, or task achievements along with invitations to sign up for the mobile app 18. As mentioned above with reference to the quality point status system, in some embodiments, accepted invitations can create a link relationship that can enhance the status of both parties by sharing fractional status points. For example, if one of a referrer or a referee completes a task with satisfactory quality, the other participant (referee or referrer) will receive a fraction of the points awarded to the task-completing participant. The fraction may be, e.g., ten percent (10%).

Thus, according to embodiments of the present invention, a customer submits a task request via the web interface, specifying store locations, desired participant activities, relevant brands, etc. The analytics engine identifies suitable participants and sends the task request to those members of the on-demand consumer workforce via the mobile app. The pre-screened consumer participants who are able to accept and complete tasks within a defined time period will receive rewards for the results they submit. The business customers can access the results via the secure web interface, and can obtain validation of the results by submitting duplicate task requests for fulfillment by distinct participants. Exemplary task requests include checks on store cleanliness, seasonal displays, private label promotions, department setup, sign installation, pricing, retail audits, new item analysis, promotion presence, and/or stockage.

Other possible features of the mobile app 18, according to embodiments of the invention, include curating grocery or general shopping lists; signalling for in-store assistance; viewing in-store offers; scanning a product to obtain comparative pricing, health information, or product reviews via image recognition module 154; retrieving electronic coupons related to scanned bar codes or QR codes.

Advantageously, the accomplishment of tasks and possible social sharing of rewards or task results may enhance consumer awareness of products targeted by the customers. For example, the invention can be leveraged to establish a contest rewarding the most unique or creative response to a photo type task on a specified product.

Although exemplary embodiments of the invention have been shown and described with reference to the appended drawings, it will be understood by those skilled in the art that various changes in form and detail thereof may be made without departing from the spirit and the scope of the invention.

What is claimed is:

1. A method for crowd sourcing business services, comprising:
maintaining a database of customer data and participant data;
receiving at a web server, from at least one customer, at least one request for a task;
adding to the customer data the at least one request for a task;
identifying at an analytics engine, based on the participant data, at least one participant suitable for performing at least one task requested by a customer;
offering from an app server, to the at least one identified participant, an opportunity to perform the requested task;
receiving at the app server, from at least a first of the at least one identified participant, a response including task data produced by performing the requested task;
assessing at the analytics engine quality of the task data;
generating at the analytics engine results based on the task data;
adding to the customer data the results; and
assigning at the analytics engine status points to the first of the at least one identified participant based on at least the quality of the task data.

2. A method as claimed in claim 1, wherein the participant data includes participant link information, further comprising assigning at the analytics engine fractional status points to participants linked with the first of the at least one identified participant.

3. A method as claimed in claim 2, wherein the participant link information is established based on participant responses to social network invitations.

4. A method as claimed in claim 1, wherein the assigned status points are positive in case the task data meets quality standards, or negative in case the task data fails to meet quality standards.

5. A method as claimed in claim 1, wherein identifying at least one participant includes evaluating at least that participant's status points.

6. A method as claimed in claim 1, wherein the participant data includes at least one of a location history or a shopping history, and identifying at least one participant includes evaluating at least one of the location history or the shopping history.

7. A method as claimed in claim 1, further comprising offering from the app server to the first of the at least one participants, in response to receipt of task data, a targeted incentive.

8. A method as claimed in claim 7, wherein the targeted incentive is offered in immediate response to receipt of task data.

9. A method as claimed in claim 7, wherein the participant data includes a location history and a shopping history, and the targeted incentive is selected based on at least the location history and the shopping history.

10. A method as claimed in claim 9, wherein the customer data includes correlation data derived from participant data including a plurality of responses, and the targeted incentive is selected based on at least two of the location history, the shopping history, and the correlation data.

11. A method as claimed in claim 1, wherein the task data include photo or video data, and assessing quality and generating results include image recognition processing of the photo or video data

12. A method as claimed in claim 11, wherein the results include numeric data based on image recognition processing of the photo or video data.

13. A method as claimed in claim 12, wherein the results include correlation data obtained at least in part through image recognition processing of the photo or video data.

14. A method as claimed in claim 13, wherein the correlation data are obtained taking into account at least one of a participant location history or a participant shopping history.

15. A method as claimed in claim 1, wherein generating results includes generating a confidence indicator based on participant status.

16. A method as claimed in claim 15, wherein the results include numeric data, and generating results includes adjusting numeric task data using a confidence weighting function based on participant status.

17. A system comprising:
a database storing customer data (comprising customer identity, customer locations, customer task requests, and customer task results) and participant data (comprising participant identity, participant available tasks, participant accepted tasks, and participant records of completed tasks);
a web server offering customer access to the database via a web interface;
an app server offering participant access to the database via a mobile app; and
an analytics engine configured to flow task requests from the customer data into the participant available tasks, configured to obtain task data from the participant records of completed tasks, to generate task results based on the task data and the participant identity, and to flow the task results into the customer data, and configured to modify participant identity based on the task data,
wherein, in response to task data provided by a participant, the app server is further configured to offer the participant an incentive via the mobile app, the incentive being relevant to the task data and to the participant's identity.

18. A system as claimed in claim 17, wherein the participant identity includes a participant status.

19. A system as claimed in claim 17, wherein the analytics engine is configured to mark a customer task request as completed in response to a change in a participant's record of completed tasks.
